(19) United States
(12) Patent Application Publication
(10) Pub. No.: US 2012/0012739 A1
(43) Pub. Date: Jan. 19, 2012

(54) OPTICAL MICRORESONATOR SYSTEM

(76) Inventors: Barry J. Koch, Woodbury, MN (US); Terry L. Smith, Roseville, MN (US); Jun-Ying Zhang, Woodbury, MN (US); Yasha Yi, New York, NY (US)

(21) Appl. No.: 13/142,019

(22) PCT Filed: Dec. 17, 2009
(86) PCT No.: PCT/US2009/068575

§ 371 Date: Sep. 19, 2011

Related U.S. Application Data
(60) Provisional application No. 61/141,303, filed on Dec. 30, 2008.

(51) Int. Cl. G01J 1/04

(52) U.S. Cl. 250/227.11

(57) ABSTRACT

An optical device includes a light source (102), an optical microresonator (118) that supports at least a first optical guided mode (128) propagating along a first direction and at least a second optical guided mode (164) propagating along a second direction different from the first direction, and a detector (110,114). At least the first optical guided mode is excited by the emitted broadband light without the second optical guided mode being excited by the emitted broadband light. In some embodiments The detector receives and wavelength-averages light from the at least a second optical guided mode of the optical microresonator. In some embodiments, at least one of the light source, the microresonator and the detector is tunable.

### FIELD OF THE INVENTION

This invention generally relates to optical devices. The invention is particularly applicable to optical devices such as optical sensors that incorporate microresonators.

### BACKGROUND

Optical sensing is becoming an important technology for detection of biological, chemical, and gaseous species. Optical sensing may offer advantages of speed and sensitivity. In recent years, many novel photonic structures and materials have been developed to make very sensitive optical devices.

One optical sensing method for analyte detection uses integrated optical waveguides. Such sensors have been demonstrated to be able to detect chemical and biological species adsorbed onto the waveguide surface. But integrated optical waveguide chemical analysis can require a large sensing device (typically several centimeters long) in order to obtain sufficient optical signal change for many analytical applications.

Optical microresonators are currently under intensive investigation for applications in biochemical, chemical, and gas sensing. Optical microresonators are very small devices that can have high quality factors (Q-factor) where Q-factor commonly refers to the ratio of a resonant wavelength to a resonance linewidth. For example, microresonators made of glass spheres can be used to make very sensitive optical sensors since the light trapped in the microsphere resonator circulates many times producing a device with a high Q-factor (>10⁶) which allows effective enhancement of the optical interaction between an analyte on the surface of the microsphere and the light circulating in the resonator. In an optical microresonator sensor a first bus waveguide is used to excite guided optical modes located close to the surface of the microresonator. One example of resonant optical modes is a whispering gallery mode. An analyte is then located within the evanescent field of the modes of the microresonator. The change in refractive index of the sensor is detected by a shift in the resonant frequencies. The shifted spectra can be extracted from the microresonator via a through port of the first bus waveguide or by using a drop port of a second bus waveguide that is connected to a detector.

A variety of types of optical microresonators have been investigated for the purpose of making optical sensors, but microspheres, microrings, and microdisks have received the most attention. Microdisks or microrings based on semiconductor fabrication processes are relatively easy to fabricate in a large quantity and/or high density. Their positions with respect to waveguides can be adjusted using fabrication technologies such as dry/wet etching and layer deposition. The Q-factors of these resonators, however, are typically below 10⁴, due at least in part to the surface roughness and to material absorption.

In the conventional approach to sensing using microresonators, bonding of an analyte to the surface of the microresonator results in a small change in the effective refractive index of the microresonator. This results in a small shift of the wavelength position of the peaks in the resonance spectrum. These shifts are typically in the picometer range. In order to detect such small shifts expensive equipment for spectral analysis is required. Furthermore, the microresonator must be designed to give a very narrow linewidth so that the small peak shifts can be detected. This requires a high finesse (free spectral range divided by linewidth), or equivalently, a high quality factor (operating wavelength divided by linewidth) microresonator. This translates to the need for low loss waveguides in the microresonator and weak coupling between the microresonator and the bus waveguide in order to detect the small frequency shift. It also requires that the fabrication of the microresonator system be done with high accuracy and little error, with the result that these systems are expensive to fabricate.

There is a need for improved optical sensing systems that use microresonators that are less expensive to manufacture.

### SUMMARY OF THE INVENTION

Generally, the present invention relates to optical devices. The present invention also relates to optical sensors that include one or more microresonators.

One embodiment of the invention is directed to an optical device that includes a light source capable of emitting broadband light and an optical microresonator that supports at least a first optical guided mode propagating along a first direction and at least a second optical guided mode propagating along a second direction different from the first direction. At least the first optical guided mode is excited by the emitted broadband light without the second optical guided mode being excited by the emitted broadband light. A broadband photodetector is disposed to receive and wavelength-average light from the at least a second optical guided mode of the optical microresonator.

Another embodiment of the invention is directed to a method of operating an optical sensing system. The method includes coupling broadband light from a light source into at least one of a first set of optically guided modes in a microresonator propagating along a first direction within the microresonator; and coupling at least some of the light in the at least one of the first set of optically guided modes into at least one of a second set of optically guided modes propagating along a second direction different from the first direction in the microresonator. At least a portion of the light from the at least one of the second set of optically guided modes is detected using a broadband, wavelength averaging photodetector.

Another embodiment of the invention is directed to an optical device that includes a broadband light source capable of emitting broadband light and an optical microresonator that supports first multiple optical guided modes propagating along a first direction and second multiple optical guided modes propagating along a second direction different from the first direction. The broadband light from the broadband light source excites at least one of the first multiple optical guided modes without substantially exciting the second multiple optical guided modes. A tunable detector is disposed to receive light from at least one of the second multiple optical guided modes of the optical microresonator.

Another embodiment of the invention is directed to a method of operating an optical sensing system that includes coupling light from a broadband light source into at least one of a first set of optically guided modes in a microresonator propagating along a first direction within the microresonator. At least some of the light in the at least one of the first set of optically guided modes is coupled into at least one of a second set of optically guided modes propagating along a second direction opposite the first direction in the microresonator. Light from at least one of the second set of optically guided modes is received at a tunable detector. A wavelength-selected portion of the received light is detected.

Another embodiment of the invention is directed to an optical device that has a narrowband light source capable of emitting narrowband light and an optical microresonator that supports first multiple optical guided modes propagating along a first direction and second multiple optical guided modes propagating along a second direction different from the first direction. The narrowband light from the narrowband light source excites at least one of the first multiple optical guided modes without substantially exciting the second multiple optical guided modes. The optical microresonator comprises a core and a tuning element coupled to tune resonant mode frequencies of the microresonator. A broadband detector receives light from at least one of the second multiple optical guided modes of the optical microresonator while the microresonator is tuned.

Another embodiment of the invention is directed to a method of operating an optical sensing system that includes coupling light from a light source into at least one of a first set of optically guided modes in a microresonator propagating along a first direction within the microresonator. The first set of optically guided modes of the microresonator is tuned over a first frequency range. At least some of the light in the at least one of the first set of optically guided modes is coupled into at least one of a second set of optically guided modes propagating along a second direction opposite the first direction in the microresonator. At least a portion of the light from the at least one of the second set of optically guided modes is detected using a broadband, wavelength averaging photodetector while tuning the first set of optically guided modes over the first frequency range.

Another embodiment of the invention is directed to an optical device that includes a tunable light source capable of emitting light and an optical microresonator that supports first multiple optical guided modes propagating along a first direction and second multiple optical guided modes propagating along a second direction different from the first direction. The light emitted by the tunable light source excites at least one of the first multiple optical guided modes without substantially exciting the second multiple optical guided modes. A broadband detector is disposed to receive light from at least one of the second multiple optical guided modes of the optical microresonator.

Another embodiment of the invention is directed to an optical device that includes a narrowband light source capable of emitting light and an optical microresonator that supports first multiple optical guided modes propagating along a first direction and second multiple optical guided modes propagating along a second direction different from the first direction. The light emitted by the light source excites at least one of the first multiple optical guided modes without substantially exciting the second multiple optical guided modes. A frequency-selective detector is disposed to receive light from at least one of the second multiple optical guided modes of the optical microresonator.

### BRIEF DESCRIPTION OF DRAWINGS

The invention may be more completely understood and appreciated in consideration of the following detailed description of various embodiments of the invention in connection with the accompanying drawings, in which:

FIG. 1 schematically illustrates an embodiment of a microresonator system that uses scattering of resonant modes, according to principles of the present invention;

FIGS. 2 and 3 schematically illustrate cross-sections through an embodiment of an integrated microresonator system of the type illustrated in FIG. 1, according to principles of the present invention;

FIG. 4 schematically illustrates another embodiment of a microresonator system that uses scattering of resonant modes, according to principles of the present invention;

FIG. 5 schematically illustrates a cross-section through an embodiment of an integrated microresonator system of the type illustrated in FIG. 4, according to principles of the present invention;

FIGS. 6-9 schematically illustrate additional embodiments of microresonator systems that use scattering of resonant modes, according to principles of the present invention; and

FIG. 10 schematically illustrates an embodiment of a tunable microresonator according to principles of the present invention.

In the specification, a same reference numeral used in multiple figures refers to the same or similar elements having the same or similar properties and functionalities.

### DETAILED DESCRIPTION

This invention generally relates to optical devices. The invention is particularly applicable to optical devices such as optical sensors that incorporate microresonators.

A recently developed approach to optical sensing using microresonators is described in which the movement of a scattering center towards or away from the microresonator causes significant signal enhancement in a microresonator system. This improvement in signal opens up the possibility of using less expensive light sources and detectors than in previous microresonator sensing systems.

Some embodiments of the present invention allow the use of broadband light sources and detectors together in a single system or, in other embodiments, permit the use of a narrowband tunable source with a broadband detector. In other embodiments, various combinations of broadband elements are used along with tunable elements. An advantage of using broadband elements is the reduced overall system cost.

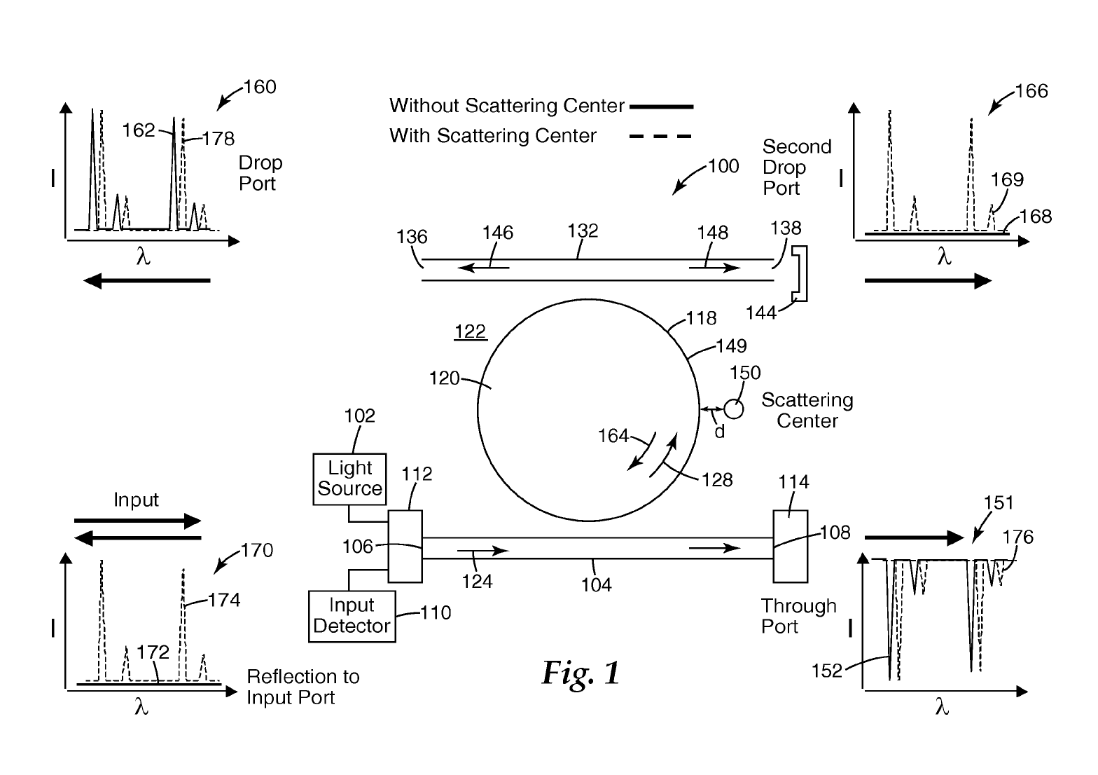

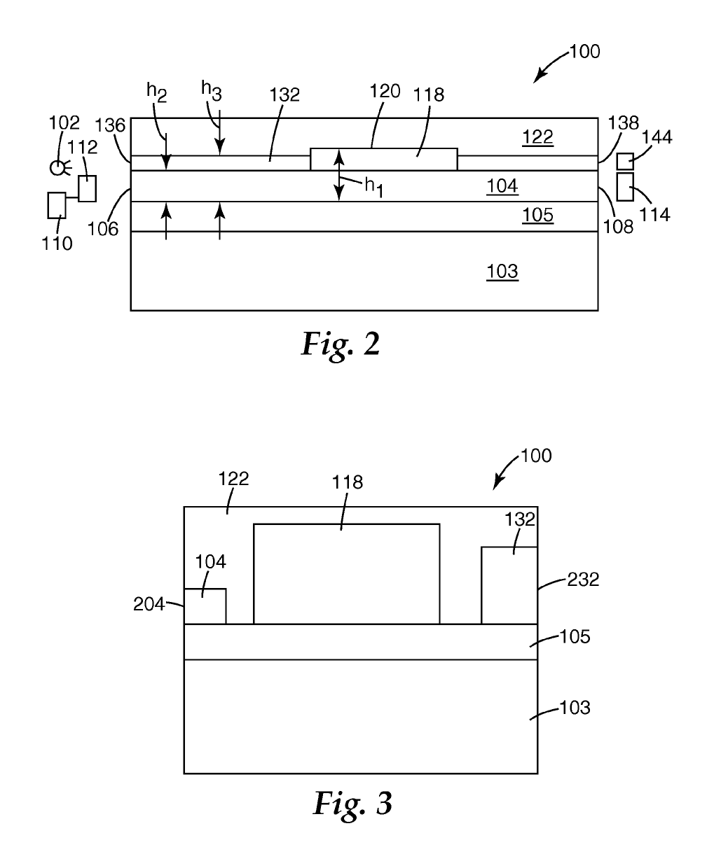

One embodiment of a microresonator-waveguide system 100 is now described, with reference to schematic top view FIG. 1. The optical system 100 includes an optical microresonator 118, a first optical waveguide 104, and an optional second optical waveguide 132. The optical waveguides 104, 132 are optically coupled to the microresonator 118. In some embodiments, for example as schematically illustrated in FIGS. 2 and 3, the microresonator 118 and waveguides 104, 132 are formed monolithically, for example as elements grown on a lower cladding layer 105 disposed on a substrate 103.

The allowed optical modes of the microresonator 118 are typically quantized into discrete modes by imposing one or more boundary conditions, such as one or more periodicity conditions. In some cases, the microresonator 118 is capable of supporting at least two different guided optical modes such as first guided optical mode 128 and second guided optical mode 164, where guided optical mode 128 is different from guided optical mode 164. In some cases, modes 128 and 164 have the same wavelength. In some cases, modes 128 and 164 have different wavelengths.

As used herein, the term “optical mode” refers to an allowed electromagnetic field in the optical configuration; the term “radiation” or “radiation mode” refers to an optical mode that is unconfined in the optical configuration; the term “guided mode” or “guided optical mode” refers to an optical mode that is confined in the optical configuration in at least one dimension typically due to the presence of a region of relatively high refractive index; and the term “resonant mode” refers to a guided mode that is subject to an additional boundary condition requirement in the optical configuration, where the additional requirement may be periodic in nature.

Resonant modes are typically discrete guided modes. In some cases, a resonant mode can be capable of coupling to a radiation mode. In general, a guided mode of the microresonator 118 can be a resonant or a non-resonant mode. For example, optical modes 128 and 164 can be resonant modes of microresonator 118.

In some cases, first guided optical mode 128 and/or second guided optical mode 164 is capable of propagating within the microresonator while maintaining a constant electric field amplitude profile. In such cases, the shape or profile of the propagating mode remains substantially the same over time even if the mode gradually loses energy because of, for example, absorption or radiation losses. In some cases the propagation direction of the first guided optical mode 128 is opposite to the propagation direction of the second guided optical mode 164.

Referring to FIGS. 1-3, a first bus waveguide 104 receives light from a light source 102. The end of the waveguide 104 that receives the light from the light source 102 is an input port 106. The other end of the waveguide 104 is termed the through port 108.

An input port detector 110 may be located at the input port 106. In some embodiments an optical component 112 is in optical communication with the light source 102, input detector 110, and input port 106 to direct input light 124 to the input port 106, and/or to direct light traveling toward the input port 106 from the first bus waveguide 104 towards the input detector 110. In certain embodiments the optical component 112 may be an optical splitter, such as a partial mirror, or an optical circulator. The input port detector 110 is in optical communication with the first bus waveguide 104 via the optical component 112.

The microresonator 118 is capable of supporting first and second resonant optical modes 128 and 164, respectively. The microresonator 118 is optically coupled to the first bus waveguide 104 and may be evanescently coupled, as is schematically illustrated in FIG. 1, or may be directly coupled as is discussed later. Light input at input port 106 is capable of optically coupling primarily to the first resonant mode 128. Light 124 from the light source 102 is launched into the first bus waveguide 104 and propagates along the first bus waveguide 104 towards the through port 108. Some of the light 124 is coupled out of the first bus waveguide 104 into the microresonator 118. Typically, the light is coupled into one or more resonant modes of the microresonator 118, such as first resonant optical mode 128. The microresonator 118 may be formed of a core 120 surrounded, at least partially, by a cladding 122. In some embodiments, for example as shown in FIGS. 2 and 3, the cladding 122 may cover both the top and the sides of the core 120. In some cases, the cladding 122 can include different materials, for example, at different locations. For example, some regions of the cladding 122 may include water or air and some other regions of the upper cladding can include another material such as glass. In general the cladding 122 is formed of a material or materials having a refractive index less than the refractive index of the core 120, which provides confinement of the light to the core 120.

In the illustrated embodiment a second bus waveguide 132 is positioned in optical communication with the microresonator 118. A first drop port 136 is located at one end of the second bus waveguide 132, while a second drop port 138 is located at another end of the second bus waveguide. The first drop port 136 is primarily capable of optically coupling to the first resonant optical mode 128 but not to the second resonant optical mode 164. The second drop port 138 is primarily capable of optically coupling to the second resonant optical mode 164 but not the first resonant optical mode 128. In some embodiments light in the first resonant optical mode 128 propagates in a first direction around the microresonator so that light coupled out of the first resonant optical mode 128 into the second bus waveguide 132 is directed primarily towards the first drop port 136.

Meanwhile, light in the second resonant optical mode 164 propagates around the microresonator 118 in the opposite direction so that light 148 coupled out of the second resonant optical mode 164 into the second bus waveguide 132 is directed primarily towards the second drop port. A second drop port detector 144 may be located at the second drop port 138. Another detector (not shown) may also be positioned at the first drop port 136.

The microresonator 118 may be positioned in physical contact with, or very close to, the waveguides 104 and 132 so that a portion of the light propagating along the waveguides is evanescently coupled into the microresonator 118. Also, a portion of light propagating within the microresonator 118 will be evanescently coupled into the waveguides 104 and 132.

FIG. 2 schematically illustrates a cross-sectional view through an embodiment of the first bus waveguide 104 and along an axis of the first bus waveguide 104. FIG. 3 schematically illustrates a cross-sectional view through the microresonator 118 and the two bus waveguides and perpendicular to an axis of the first bus waveguide 104. Each of the first and second optical waveguides 104, 132 may be formed from a core disposed between multiple claddings. For example, the first optical waveguide 104 has a core having a thickness h₂ and is disposed between upper cladding 122 and lower cladding 105. Similarly, the second optical waveguide 132 may have a core having a thickness h₃ disposed between upper cladding 122 and lower cladding 105. In some cases, the cladding 122 can include air or water.

In the exemplary optical device 100 of FIGS. 1-3, microresonator 118 and optical waveguides 104 and 132 have different thicknesses, h₁, h₂, and h₃. In general, the values of h₁, h₂, and h₃ may or may not have the same value. In some applications, microresonator 118 and optical waveguides 104 and 132 have the same thickness.

The effect of an external scattering center 150 upon the operation of the microresonator system 100 is an interesting aspect of the optical system. However, before the effect of the scattering center 150 is described, the use of a microresonator system 100 without a scattering center 150 will be described.

In one conventional approach to sensing using microresonators, a surface 149 of a core 120 of the microresonator 118 is functionalized to be capable of chemically specific bonding with an analyte. Bonding of an analyte to the surface of the microresonator 118 causes a small change in the effective refractive index experienced by light propagating within the microresonator 118, which shifts the wavelength position of the peaks in the resonator spectrum. These shifts can be observed in the light detected at the through port 108 and the first drop port 136. Hence, the detection of a shift of the dips of the transmission spectrum at the through port 108 and/or the peaks at the first drop port 136 may indicate the presence of an analyte. Other conventional approaches to sensing using microresonators exist, and some examples of various approaches are detailed in U.S. Published Patent Application 2006/0062508 which is incorporated herein by reference.

Light 124 emitted by the light source 102 travels through the first bus waveguide 104 and the microresonator 118 couples some of the light 124 out of the first bus waveguide 104, so that the out-coupled light propagates within the microresonator 118 at one or more of the resonant frequencies of the microresonator 118, for example as first optical resonant mode 128. One example of resonant modes of a microresonator is “whispering gallery modes”. In geometric optics, light rays in a whispering gallery mode (WGM) propagate around the microresonator from an origin via a number of total internal reflections, until they return to the origin. In these WGMs the phase of the light starting at the origin is the same as the phase of the light at the origin after one trip around the microresonator, and so the WGMs are resonant modes. In addition to WGMs, many other resonant modes are possible for microresonators.

For a high-quality microresonator 118 in the absence of a scattering center 150, light in the first resonant mode 128 couples to the through port 108 and to the drop port 136, where a detector can detect the spectrum of the resonant frequencies in the microresonator. The resonant mode 128 couples weakly or essentially does not couple to the second drop port 138 or the input port 106. Through port output graph 151 illustrates an example of the light spectrum that is detected at the through port 108, showing intensity as a function of wavelength. The plot 152 (solid line) is an example of a light spectrum that may be detected in the absence of a scattering center. The plot 152 shows that light at most wavelengths passes along the first bus waveguide 104 to the through port 108, with various intensity minima representing those wavelengths that are coupled into the microresonator 118. The effective refractive index experienced by light propagating within the microresonator 118 is modified, for example, due to bonding of an analyte to the surface of the microresonator 118. This change in effective refractive index results in a shift in the wavelengths of the intensity minima on the order of a few picometers. Thus, bonding of an analyte to the surface 149 of the microresonator can be detected in one example of conventional sensing systems.

Similarly, light in the first guided optical mode 128 propagating within the microresonator 118 couples to the second bus waveguide 132 as light 146 and may be detected at the first drop port 136. Drop port output graph 160 illustrates an example of the light spectrum that may be detected at the first drop port 136, showing intensity plotted against wavelength. The plot 162 (solid line) is an example of a light spectrum that may be detected without a scattering center. The peaks of plot 162 represent light that has been coupled out of the resonant modes of the microresonator 118. The peaks experience a shift on the order of a few picometers when the effective refractive index of the microresonator 118 is modified due to bonding of an analyte to the surface 149 of the waveguide.

In order to detect a spectrum shift on the order of a few picometers at the first drop port 136 or through port 108, a fairly expensive tunable narrow-linewidth laser source may be used to scan the relevant spectral region of the resonator output spectrum. Alternatively, a broadband source may be used along with a spectrum analyzer, which is typically an expensive combination. In addition, the microresonator 118 is designed with resonant modes of relatively narrow linewidth, so that the small peak shifts, of the order of picometers, can be detected. The microresonator yields a narrow linewidth when the finesse is high, the finesse being defined as the free spectral range divided by the linewidth. A high finesse microresonator also has a high quality factor, which is defined as the operating wavelength divided by linewidth. Narrow linewidth can be achieved, for example, by using a low loss resonator that is weakly coupled to the bus waveguides. These requirements result in a more demanding manufacturing process for the microresonator 118, resulting in more expensive sensor systems.

Compared to the exemplary sensing approach described above, the use of a scattering center leads to much larger changes in the spectral positions of resonance peaks at the drop port 136 and through port 108, typically on the order of nanometers instead of picometers. In addition, large changes in the broadband transfer characteristics of the resonator are observed. These transfer characteristics can be observed at the second drop port 138 and input port 106 and have the potential to simplify the system by reducing the requirements on the linewidth of the light from the light source 102 and/or the wavelength resolution of the detector.

According to some embodiments of the present invention, the strength of optical coupling between a scattering center and a microresonator is altered during a sensing event. This occurs by, for example, a scattering center becoming optically coupled to the microresonator, or by a scattering center being removed from optical coupling with the microresonator. When the scattering center is optically coupled to the microresonator, the optical fields of one or more of the resonator's resonant modes overlap with the scattering center.

A scattering center 150 is an element that provides some spatial non-uniformity to the effective refractive index experienced by the resonant modes of the microresonator 118 along the direction of propagation. The magnitude of the non-uniformity depends on several factors, including the refractive indices of the microresonator core 120 and cladding 122, and the refractive index of the scattering center 150. The magnitude of the non-uniformity also depends on the spatial separation between the scattering center 150 and the core 120: the nonuniformity increases in size when the scattering center 150 comes closer to the core 120.

When optically coupled to a microresonator 118, the scattering center 150 is able to perturb the wave function of the resonant modes within the microresonator 118 to cause a transfer of energy from modes that are excited by input light source 102 to modes that are not, or are only minimally, excited by light from the input light source 102. In the present example, the first resonant optical mode 128 is excited by light from the light source 102, while the second optical resonant mode 164 remains substantially not excited by light from the light source 102. The second optical resonant mode 164 when the scattering center approaches the microresonator 118 sufficiently closely that light is scattered from the first optical resonant mode 128 into the second optical resonant mode 164. In some embodiments, the presence of the scattering center 150 increases the transfer of energy from a first mode to a second mode, even though some transfer of energy from the first mode to second mode may occur even in the absence of the scattering center. Also, in some embodiments, such as that illustrated in FIG. 1, the light in the first optical resonant mode 128, excited directly by light from the light source 102, propagates in a first direction around the microresonator 118, while the light in the second optical resonant mode 164, excited by scattering from the first optical resonant mode 128, propagates in a second direction around the microresonator 118 that is opposite the first direction.

Examples of scattering centers that may be used with sensing methods of the present invention include particles, for example nanoparticles. As used herein, the term “nanoparticle” refers to a particle having a maximum dimension of around 1000 nanometers or less. In certain embodiments, the scattering center is at least 20 nanometers, at most 100 nanometers, or both. In other embodiments, the scattering center is at least 10 nanometers, at most 150 nanometers, or both. In some embodiments of the invention particles that have a dimension larger than 1000 nanometers may be used as scattering centers.

In some embodiments of the invention, the scattering center has a high index difference compared to the medium that surrounds the scattering center during a sensing event, which may be water. In an embodiment of the invention, the scattering center has a high absorption value. For example, the imaginary part of the complex refractive index of the scattering center material is at least 1.

In some cases, for example as in the case of some metals such as gold, the real part of the index of refraction of the scattering center is less than 1. In some other cases, such as in the case of silicon, the real part of the index of refraction of the scattering center is greater than 2.5.

Examples of scattering centers that are appropriate for use with the invention include, but are not limited to, semiconductor particles and metal particles, including gold and aluminum particles. In some cases, a scattering center may be a semiconductor such as Si, GaAs, InP, CdSe, or CdS. For example, a scattering center may be a silicon particle having a diameter of 80 nanometers and an index of refraction (the real part) of 3.5 for a wavelength of interest. Another example of a scattering center is a gold particle having a diameter of 80 nanometers and an index of refraction of 0.54+9.58 i for wavelengths near 1550 nm. Another example of a scattering center is an aluminum particle having a diameter of 80 nanometers and an index of refraction of 1.44+16.0 i for wavelengths near 1550 nm.

In other embodiments, the scattering center may be a dielectric particle, for example a metal oxide, metal nitride or metal oxynitride, or may be formed of a organic materials such as a polymer, polymer blend or the like. The particle may be formed of a material that is magnetic. The scattering center may or may not be formed of a fluorescent material. In some embodiments the scattering center may be a core-shell particle, for example a core-shell nanoparticle, in which a core of a first material is encapsulated by a shell of a second material. While not intending to limit the materials that may be used for the core shell particle, any of the materials listed above may be used for either the core of the shell. For example, the core-shell particle may include a metal core covered by an organic shell. In addition, core materials may include liquids or gases, such as air.

When a scattering center 150 is in optical communication with the microresonator 118, typically evanescent optical communication, light in the first resonant optical mode 128 is scattered into at least a second guided optical mode 164, different from the first resonant optical mode 128. Light in the second guided optical mode 164 couples primarily to the input port 106 and the second drop port 138. Graph 166 illustrates the spectrum of the light output at the second drop port 138. The solid line 168 is the plot of light output when no scattering center 150 is present, or when the scattering center 150 is sufficiently removed from the core 120 that no scattering takes place: essentially no, or very little, light is distributed to the second drop port 138. The plot 169 (dashed line) illustrates the spectrum of light output at the second drop port 138 when a scattering center 150 is in optical communication with the microresonator 118. Significant peaks are observed in plot 169. The presence of a scattering center 150 leads to a transfer of energy to the second drop port 138 for a broad range of operating frequencies. As a result, it is possible to detect whether a scattering center 150 is attached to the microresonator 118 by monitoring the output at the second drop port 138. The output can be monitored for larger peaks at specific wavelengths and/or for greater light output across all wavelengths.

A similar change may be observed for light exiting the input port 106. Graph 170 illustrates the spectrum of light output from the input port 106, as detected by the input port detector 110. Plot 172 (solid line) illustrates the light output when no scattering center 150 is present, which is at, or close to, zero across all wavelengths, or at least is low in amplitude. Plot 174 (dashed line) illustrates the spectrum of light output when a scattering center 150 is in optical communication with the microresonator 118. Significant peaks are observed in plot 174 compared to plot 172. The presence of a scattering center therefore leads to a transfer of energy reflected back to the input port 106 for a broad range of operating wavelengths. As a result, it is possible to detect whether a scattering center 150 is attached to the microresonator 118 by monitoring the output of light at the input port 106. The output can be monitored for larger peaks at specific wavelengths and/or for greater light output across all wavelengths.

Optical scattering from the first resonant mode 128 to the second resonant mode 164 due to a scattering center 150 can be observed at the input port 106, at the second drop port 138 or at both locations. Accordingly, various embodiments include detectors at the input port 106 only, at the second drop port 138 only, or at both the input port 106 and the second drop port 138. The change in the optical coupling between a scattering center 150 and the microresonator 118 may also cause a change in the output observed at the through port 108 and at the drop port 136.

In some embodiments a scattering center with a refractive index that is different from that of the cladding materials of the environment can induce a significant resonance frequency shift on the scale of nanometers. For example, in many biosensing applications the cladding material of the environment is water. In some cases, there is a large difference between the cladding's refractive index and the scattering center's refractive index. Each refractive index may be a complex index of refraction. The resulting frequency shift is conceptually illustrated in FIG. 1. At the through port 108, the solid line 152 of graph 151 illustrates the spectrum that is detected at through port detector 114 without a scattering center present. Plot 176 (dashed line) illustrates the spectrum that is detected when a scattering center is brought into optical coupling with the microresonator, where the peaks are shifted compared to plot 152. In the exemplary graph 151, the shift between plots 152 and 176 is toward longer wavelengths or a red shift corresponding to, for example, the real part of the refractive index of the scattering center being greater than the index of the cladding materials.

A similar change may be seen at the drop port 136, where plot 178 (dashed line) illustrates the detected spectrum when a scattering center 150 is present, and plot 162 (solid line) illustrates the detected spectrum without a scattering center 150.

A microresonator sensing system using a scattering center is described further in co-owned U.S. Patent Publication No. 2008/0129997A1, filed on Dec. 1, 2006 and published on Jun. 5, 2008, and in U.S. Patent Publication No. 2008/0131049A1, filed on Dec. 1, 2006 and published on Jun. 5, 2008, both of which are incorporated herein by reference.

When the scattering center 150 is removed from optical proximity to the microresonator 118, such removal induces a change in the optical scattering between the first and second guided optical modes 128 and 164. The detectors 110 or 144 can detect the change in transfer of energy between the guided optical modes 128 and 164 and, by doing so, are capable of detecting the removal of the scattering center 150.

A change in the strength of optical coupling between scattering center 150 and the microresonator 118 can induce a change in the optical scattering between first and second guided optical modes 128 and 164. The change in the strength of optical coupling between the scattering center 150 and the microresonator 118 can be achieved in various ways. For example, a change in the spacing “d” between the scattering center 150 and the microresonator 118 can change the strength of optical coupling between the scattering center and the microresonator. As another example, a change in the index of refraction nₛ of the scattering center 150 can change the strength of optical coupling between the scattering center and the microresonator. In general, any mechanism that can cause a change in the strength of optical coupling between the scattering center 150 and the microresonator 118 can induce a change in the optical scattering between guided modes 128 and 164.

The optical system 100 can be used as a sensor, capable of sensing, for example, an analyte. For example, the microresonator 118 may be capable of bonding with the analyte. Such bonding capability may be achieved by, for example, a suitable treatment of the outer surface of the microresonator 118. In some cases, the analyte is associated with the scattering center 150. Such an association can, for example, be achieved by attaching the analyte to the scattering center 150. The scattering center 150 may be brought in optical proximity to the microresonator 118 when the analyte bonds with the outer surface of the microresonator. The scattering center 150, therefore, induces optical scattering between the first and second guided optical modes 128 and 164. The optical detectors 110 and 144 can detect the presence of analyte by detecting the change in transfer of energy between the guided optical modes 128 and 164. The analyte can, for example, include a protein, a virus, or a DNA.

In some cases, the analyte can include an antigen that is to be detected. A first antibody of the antigen to be detected can be associated with the scattering center 150. A second antibody of the antigen can be associated with the microresonator 118. The antigen facilitates bonding between the first and second antibodies. As a result, the scattering center 150 is brought into proximity to the microresonator 118 and induces a change in optical scattering within the microresonator 118 which is detected optically. In some cases, the first antibody can be the same as the second antibody. Such an exemplary sensing process can be used in a variety of applications such as in food safety, food processing, medical testing, environmental testing, and industrial hygiene.

The microresonator 118 and optical waveguides 104 and 132 can be made using known fabrication techniques. Exemplary fabrication techniques include photolithography and dry/wet etching, printing, casting, extrusion, and embossing. Different layers in optical device 100 can be formed using known methods such as sputtering, plasma enhanced chemical vapor deposition (PECVD), other vapor deposition methods, flame hydrolysis, casting, or any other deposition method that may be suitable in an application.

The substrate 103 can be rigid or flexible. The substrate 103 may be optically opaque or transmissive. The substrate 103 may be polymeric, a metal, a semiconductor, or any type of glass. For example, the substrate 103 can be silicon. As another example, the substrate 103 may be float glass or may be made of organic materials such as polycarbonate, acrylic, polyethylene terephthalate (PET), polyvinyl chloride (PVC), polysulfone, and the like.

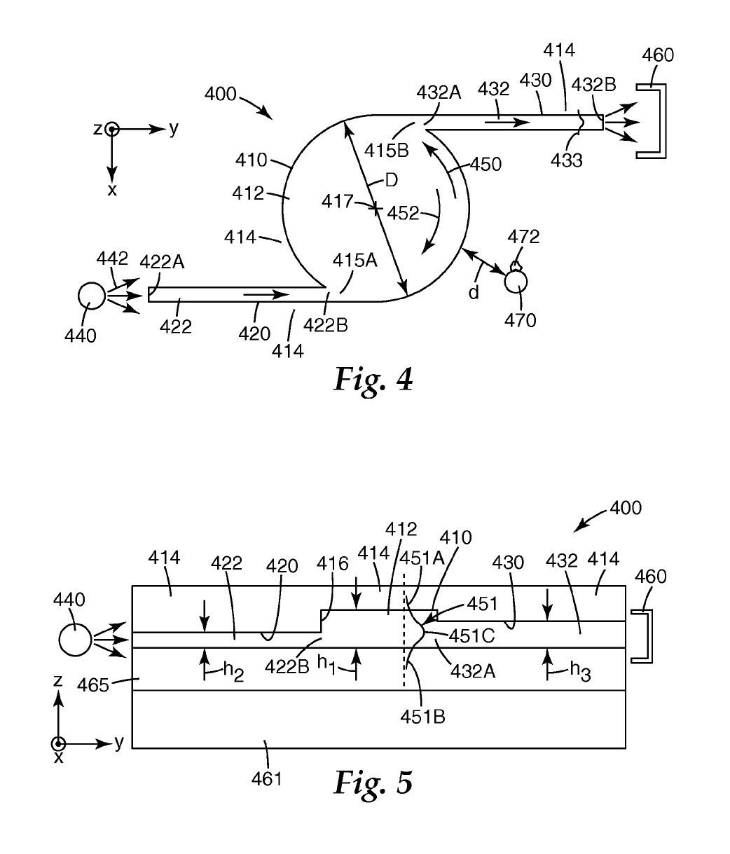

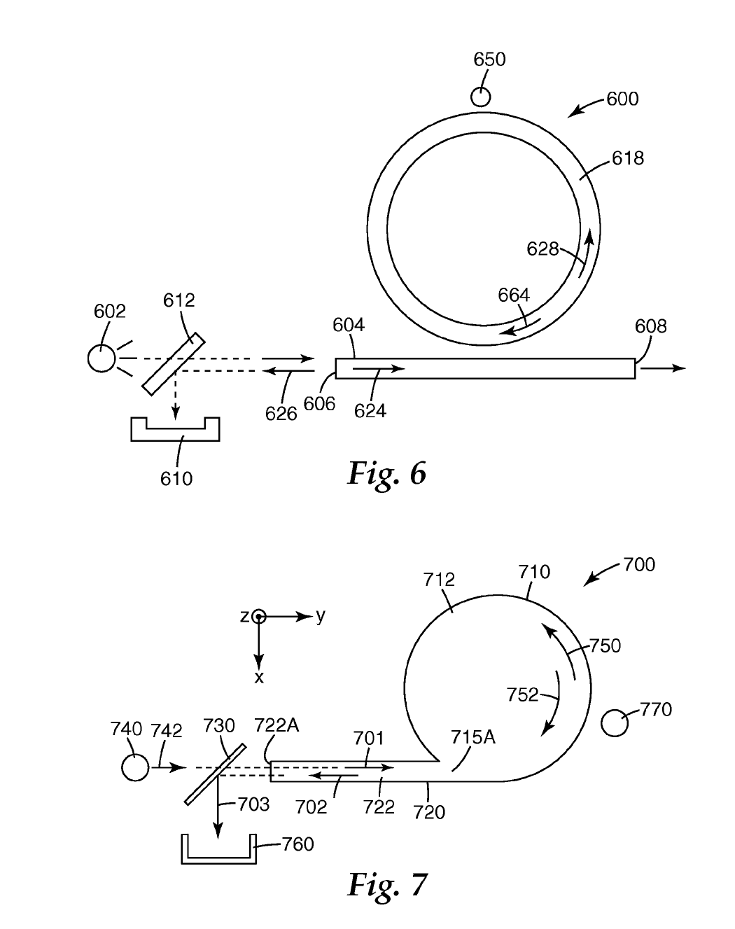

FIGS. 4 and 5 respectively show schematic top- and side-views of an embodiment of an integrated optical microresonator system 400. In this embodiment the optical system 400 includes an optical microresonator 410, a first optical waveguide 420, and a second optical waveguide 430 all disposed on a lower cladding layer 465 disposed on a substrate 461.

In general, the microresonator 410 may be single mode or multimode along a particular direction. For example, microresonator 410 can be single or multimode along the thickness direction (e.g., the z-direction) of the microresonator. In some cases, such as in the case of a sphere- or disc-shaped microresonator, the microresonator can be single or multimode along a radial direction. In some cases, such as in the case of a disk-shaped microresonator, guided optical modes 450 and 452 of microresonator 410 can be azimuthal modes of the microresonator.

In certain embodiments the microresonator 410 includes a core or cavity 412 disposed between lower cladding 465 and an upper cladding 414. The core 412 has an average thickness h₁. In general, for an electric field associated with a mode of microresonator 410, the evanescent tails of the field are located in the cladding regions of the microresonator and the peak(s) or maxima of the electric field are located in the core region of the microresonator. For example, as schematically shown in FIG. 5, a guided mode 451 of microresonator 410 has an evanescent tail 451A in the upper cladding 414, an evanescent tail 451B in the lower cladding 465, and a peak 451C in the core 412. The guided optical mode 451 can, for example, be either mode 450 or 452 of the microresonator.

In the exemplary optical system 400, the core 412 is disposed between two cladding layers 414 and 465. In general, the microresonator 410 can have one or more upper cladding layers and one or more lower cladding layers. In some cases, lower cladding layer 465 may not be present in optical device 400. In such cases, the substrate 461 can act as a lower cladding layer for the microresonator 410, in other words the refractive index of the substrate is lower than the refractive index of the core 412 of the microresonator 410. In some other cases, the microresonator 410 does not include upper cladding layer 414. In such cases, an ambient medium, such as ambient air or water, can form the upper cladding of the microresonator.

The core 412 has an index of refraction nₘ, the cladding 414 has an index of refraction n_{uc}, and the cladding 465 has an index of refraction n_{1c}. In general, nₘ is greater than n_{uc}, and n_{1c}, for at least one wavelength of interest and along at least one direction. In some applications, nₘ is greater than n_{uc}, and n_{1c}, in a wavelength range of interest. For example, nₘ can be greater than n_{uc}, and n_{1c}, for wavelengths in a range from about 400 nm to about 1200 nm. As another example, nₘ can be greater than n_{uc}, and n_{1c}, for wavelengths in a range from about 700 nm to about 1500 nm.

The microresonator core 412 has an input port 415A and an output port 415B, where output port 415B is different from input port 415A. For example, in the exemplary optical device 400, input port 415A and output port 415B are located at different locations around an outer surface 416 of core 412.

Each of the first and second optical waveguides 420 and 430 may have a core disposed between multiple claddings. In the illustrated embodiment, the first optical waveguide 420 has a core 422 having a thickness h₂ and is disposed between upper cladding 414 and lower cladding 465. Similarly, the second optical waveguide 430 has a core 432 having a thickness h₃ disposed between upper cladding 414 and lower cladding 465.

Core 422 has an index of refraction n_{w1} which is, in general, greater than n_{uc}, and n_{1c}. Similarly, core 432 has an index of refraction n₂ which is, in general, greater than n_{uc}, and n_{1c}.

In some cases, cores 412, 422, and 432 may be made of different core materials having the same or different indices of refractions. In some other cases, cores 412, 422, and 432 may form a unitary construction, meaning that the cores form a single unit with no physical interfaces between connecting cores. In a unitary construction, the cores may be made of the same core material. A unitary construction can be made using a variety of known methods such as etching, casting, molding, embossing, and extrusion.

Core 422 has an input 422A and an output 422B. Input 422A is in optical communication with a light source 440. The output 422B physically contacts input port 415A of core 412. In some cases, such as in a unitary construction, the output 422B can be the same as input port 415A. In some cases, there is significant overlap between the output 422B and the input port 415A. In some cases, one of the output 422B and the input port 415A completely covers the other. For example, in some cases, the output 422B is larger than and completely covers the input port 415A of the microresonator 410.

Core 432 has an input 432A and an output face 432B. Output face 432B is in optical communication with an optical detector 460. Input face 432A is in physical contact with output port 415B of core 412 of microresonator 410.

Light source 440 is capable of emitting light beam 442, at least a portion of which enters first optical waveguide 420 through input face 422A. In some cases, light entering optical waveguide 420 from light source 440 can propagate along the waveguide as a guided mode of the waveguide. First optical waveguide 420 and input port 415A are so positioned, for example, relative to each other and/or the microresonator, that light traveling in first optical waveguide 420 along the positive y-direction toward input port 415A is capable of coupling primarily to first guided optical mode 450 of the microresonator but not to second guided optical mode 452 of the microresonator. For example, light propagating along optical waveguide 420 and reaching output face 422B is capable of exciting primarily first guided optical mode 450 but not second guided optical mode 452. In some cases, there may be some optical coupling between light propagating in optical waveguide 420 and guided optical mode 452. Such coupling may be by design or due to, for example, optical scattering at input port 415A. As another example, such coupling may be due to optical scattering from manufacturing or fabrication defects. In cases where there is some optical coupling between light propagating in optical waveguide 420 and guided optical mode 452, the propagating light primarily couples to optical mode 450.

Second optical waveguide 430 and output port 415B are so positioned, for example, relative to one another and the microresonator 410, that light traveling in second optical waveguide 430 along the positive y-direction away from output port 415B is capable of coupling primarily to second guided optical mode 452 of the microresonator but not to first guided optical mode 450 of the microresonator. For example, guided mode 452 at or near output port 415B is capable of exciting a guided mode 433 in the second optical waveguide propagating along the positive y-direction toward output face 432B. In contrast, guided optical mode 450 is not capable of or is weakly capable of exciting guided mode 433. In some cases, there may be some optical coupling between guided optical mode 450 and guided mode 433 due to, for example, optical scattering at output port 415B. But any such coupling is secondary to the optical coupling between guided modes 452 and 433.

Optical waveguides 420 and 430 can be any type of waveguide capable of supporting an optical mode, such as a guided mode. Optical waveguides 420 and 430 can be one-dimensional waveguides such as planar waveguides, where a one-dimensional waveguide refers to light confinement along one direction. In some applications, optical waveguides 420 and 430 can be two-dimensional waveguides where a two-dimensional waveguide refers to light confinement along two directions. Exemplary optical waveguides include a channel waveguide, a strip loaded waveguide, a rib or ridge waveguide, and an ion-exchanged waveguide.

One advantage of a microresonator system such as that shown in FIGS. 4 and 5, in which the waveguide couples directly to the microresonator is elimination of a coupling gap between at least one optical waveguide and a microresonator. A gap is typically present between an optical waveguide and a microresonator in prior microresonator systems. In such cases, the light is evanescently coupled between the waveguide and the microresonator. Such a coupling is very sensitive to, among other things, the size of the coupling gap. In manufacturing situations, the gap size is typically hard to reproducibly control because of, for example, fabrication errors. Even in fabrication methods where the gap can be controlled with sufficient accuracy, such control can significantly increase the manufacturing cost. In those embodiments in which the coupling gap is eliminated by providing direct physical contact between the core of an optical waveguide and the core of an optical microresonator, the manufacturing costs may be reduced and reproducibility improved.

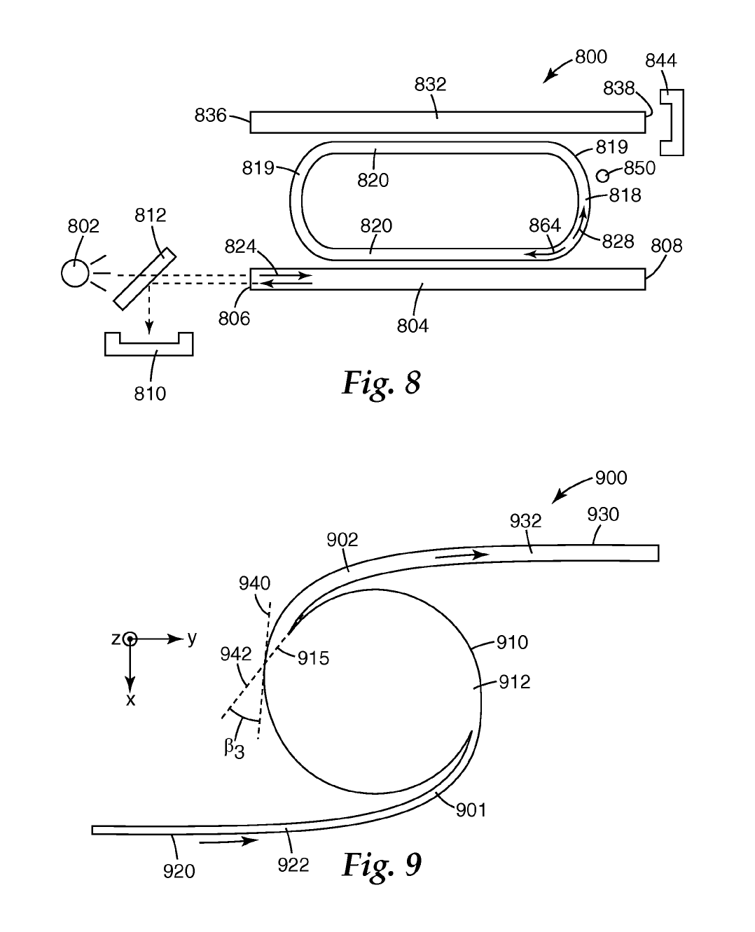

FIG. 6 is a schematic illustration of a single bus ring microresonator system 600, where a light source 602 is in optical communication with the single waveguide 604 at an input port 606. An input port detector 610 is positioned at the input port 606. An optical component 612, such as an optical splitter or optical circulator, is in optical communication with the input port 606, the light source 602, and the input port detector 610.

A ring microresonator 618 is in optical communication with the waveguide 604. Light 624 from the light source 602 is launched into the first bus waveguide 604 and propagates towards the through port 608. The microresonator 618 evanescently couples some of the light 624 out of the first bus waveguide 604, the out-coupled light propagates within the microresonator 618 at one or more of the resonant frequencies of the microresonator 618, such as first resonant optical mode 628.

During a sensing event according to one embodiment of the present invention, the strength of optical coupling between a scattering center 650 and a microresonator 618 is altered. When the scattering center 650 is in optical communication with the microresonator 618, light in the first guided optical mode 628 may be scattered to at least a second guided optical mode, for example mode 664, different from the first guided optical mode 628. The light in the second guided optical mode 664 couples primarily to the input port 606 and exits the input port as light 626. The presence of the scattering center 650 leads to a relatively large transfer of energy reflected back to the input port 606 over a broad range of operating frequencies. As a result, the change of coupling of the scattering center 650 can be ascertained by monitoring light 626 at the input port 606 via detector 610.

In an alternate embodiment, the ring resonator may be 618 replaced with a disk resonator.

FIG. 7 shows a schematic top-view of another microresonator system 700 that includes a microresonator 710 capable of supporting at least first and second guided optical modes 750 and 752, respectively, where the second guided optical mode 752 is different from first guided optical mode 750. The system 700 further includes a single optical waveguide 720 coupled to the microresonator 710. The microresonator 710 has a core 712 and the optical waveguide 720 has a core 722. For simplicity and without loss of generality some parts of the microresonator and the optical waveguide, such as the cladding(s), are not explicitly shown or identified in FIG. 7.

The waveguide core 722 has an input 722A that is in optical communication with the light source 740. The other end of the waveguide core 722 terminates at port 715A of the microresonator core 712. The optical waveguide 720 and the port 715A are so arranged relative to each other and the microresonator core 712 that light propagating along the positive y-direction in the optical waveguide 720, such as light 701, is capable of coupling primarily to the first guided optical mode 750 but not to the second guided optical mode 752 of the microresonator 710. The optical waveguide 720 and the port 715A are furthermore so arranged that light propagating along the negative y-direction in optical waveguide 720 from the microresonator 710, such as light 702, is capable of coupling primarily from the second guided mode 752 but not from the first guided optical mode 750 of microresonator 710.

The light source 740 is capable of emitting light 742. At least a portion of the light 742 enters the optical waveguide 720 through the input 722A of the waveguide and propagates in a direction substantially parallel to the y-axis as light 701. In some cases the light 701 can be a guided mode of the optical waveguide 720. At port 715A, at least some of the light 701 optically couples into the first guided optical mode 750 of the microresonator 710. In some cases the light 701 may weakly couple to the second guided optical mode 752, but any such coupling is typically weak and secondary to the optical coupling into the first guided optical mode 750.

When the scattering center 770 is brought into optical proximity with the microresonator 710, the scattering center 770 induces optical scattering between the first guided optical mode 750 and the second guided optical mode 752, resulting in a transfer of optical energy from the first guided optical mode 750 to the second guided optical mode 752. If the second guided optical mode 752 is excited in the microresonator 710 prior to the scattering by the scattering center 770, then the introduction of the scattering center 770 results in an increase in the amount of light present in the second guided optical mode 752.

Some of the light in the second guided optical mode 752 optically couples to the optical waveguide 720 and propagates inside the waveguide 720 as light 702 towards the input 722A. An optical element 730 redirects at least a portion of the light 702 as detectable light 703 towards the detector 760. The detector 760 detects the transfer of energy between the guided optical modes 750 and 752 and, by doing so, is capable of detecting the presence of scattering center 770.

The optical element 730 redirects by, for example, reflecting at least a portion of light 702 along the x-axis as light 703 while transmitting at least a portion of input light 742. The optical element 730 can be a beam splitter or, in other embodiments, may be an optical circulator.

FIG. 8 presents a schematic view of an embodiment of a double bus waveguide racetrack microresonator system 800, where a light source 802 is in optical communication with a first waveguide 804 at an input port 806. An input port detector 810 is positioned at the input port 806. A through port 808 may be present at the other end of the first waveguide 804. An optical component 812, such as an optical splitter or optical circulator, is in optical communication with the input port 806, the light source 802, and the input port detector 810.

Light 824 from the light source 802 is launched into the first bus waveguide 804 and propagates towards the through port 808. A racetrack microresonator 818 includes two curved portions 819 and two linear portions 820. The microresonator 818 evanescently couples some of the light 824 out of the first bus waveguide 804, the out-coupled light propagates within the microresonator 818 at one or more of the resonant frequencies of the microresonator 818, such as first resonant optical mode 828. In some cases, the racetrack 818 is a single transverse mode racetrack, meaning that the racetrack supports a single mode in a direction transverse to the direction of light propagation within the microresonator 818. In some other cases, the microresonator 818 may support multiple optical transverse modes.

A second bus waveguide 832 may be positioned in optical communication with the microresonator 818. A first drop port 836 is located at one end of the second bus waveguide 832, while a second drop port 838 is located at another end of the second bus waveguide 832. The first drop port 836 is primarily capable of optically coupling to the first guided optical mode 828. The second drop port 838 is capable of weak coupling, or is not capable of coupling, to the first guided optical mode 828. A second drop port detector 844 is located at the second drop port 838. The second drop port is capable of coupling to the second guided optical mode 864.

The optical scattering within the microresonator 818 from the first guided optical mode 828 to the second guided optical mode 864 due to the presence of a scattering center 850 can be observed at the input port 806, at the second drop port 838 or at both locations. Accordingly, various embodiments include a detector in optical communication with the input port 806, a detector in optical communication with the second drop port 838, or first and second detectors in optical communication with the input and second drop ports 806 and 838, respectively.

Additional embodiments of microresonator waveguide systems that are configured to induce optical scattering from a first resonant guided optical mode to at least a second guided optical mode are illustrated and described in U.S. Patent Publications 2008/0129997A1 and 2008/0131049A1.

The optical waveguides extend linearly in the exemplary optical devices shown in FIGS. 1-8. In general, an optical waveguide coupled to a microresonator can have any shape that may be desirable in an application. For example, in the optical device 900 shown schematically in FIG. 9, the optical waveguides 920 and 930 have curved portions, such as curved portions 901 and 902. The core 932 of waveguide 930 intersects core 912 of the microresonator 910 at an attachment location 915. The angle between cores 932 and 912 is β₃, defined as the angle between the line 940 which is a tangent to the core 932 at location 915 and the line 942 which is a tangent to core 912 at the same location.

In some cases, the curvature of a curved portion of a waveguide is sufficiently small that the curvature results in no or little radiation loss. In some cases, an optical waveguide coupled to a microresonator can be a nonlinear waveguide, a piecewise linear waveguide, or a waveguide that has linear and nonlinear portions.

In some cases, at least one of first and second guided optical modes can be a traveling guided mode of the microresonator. For example, the first and second guided optical modes may be “whispering gallery modes” (WGMs) of a microresonator. A WGM is generally a traveling mode confined close to the peripheral surface of a microresonator cavity and has relatively low radiation loss. Since the WGMs are confined near the outer surface of the core of a microresonator, they are well-suited to optical coupling with analytes on or near the microresonator surface.

Traveling guided optical modes may propagate in opposite directions around the microresonator. For example, in a disk or sphere microresonator, the first guided optical mode can generally propagate in a counter-clockwise direction while the second guided optical mode can generally propagate in a clockwise direction. In such a case the first and second guided optical modes are counter-propagating optical modes.

In some cases, at least one of first and second guided optical modes can be a standing-wave mode of the microresonator. A standing-wave mode can be formed by, for example, a superposition of two traveling modes having a proper phase relationship. In some cases, one of the two traveling modes can be a reflection of the other traveling mode.

Many different types of light sources may be used in the microresonator systems disclosed herein. While the invention is not restricted to only semiconductor light sources, semiconductor light sources such as semiconductor diode lasers and light emitting diodes (LEDs), are well suited to integration with the rest of the microresonator system and provide for reasonable coupling efficiencies from the light source to the bus waveguide. Larger, distributed light sources such as lamps may also be used but may suffer from low coupling efficiency to the bus waveguide. Another type of light source that may be used is a fiber-based light source, where the species that generate the light are incorporated within the fiber itself. For example, a fiber amplifier may provide light at one end when optically pumped. Such light may be in the form of amplified spontaneous emission (ASE).

A light source is said to be “broadband” when the width of the output spectrum of the light emitted by the light source is broader than the free spectral range of the microresonator. A light source is considered to be “narrowband” if the width of the output spectrum is less than the free spectral range of the microresonator. The width of an output spectrum is taken as being the full width, half maximum (FWHM) width. Where the output of a laser is a multimode output, the width of the output spectrum is the width of the envelope that encompasses the different modes of the output. If the width of the envelope is broader than the free spectral range of the microresonator, then the laser is considered to be a broadband source.

In some embodiments, an LED or diode laser may be integrated with an optical fiber pig-tail and the output from the fiber pig-tail directed to the input bus waveguide. A semiconductor diode laser may emit light in a single longitudinal mode, or may produce a multiple longitudinal mode output. Since diode lasers are typically brighter light sources than LEDs, lasers may be advantageous in situations of low signal to noise at the detector. Brightness is usually measured in units of Watts per steradian.

Additionally, the semiconductor laser, whether the output is single mode or multimode, may be tuned so that the output spectrum of the laser can be swept over a range of wavelengths. The semiconductor laser may advantageously be tuned so that the frequency of one or more of the output modes can be matched to the frequency of one or more of the modes of the microresonator. Diode lasers may be tuned in several ways. For example, a change in the operating temperature of the laser results in a change in the frequency of the output light. The operating temperature can be changed, for example, by applying heat to the laser or by changing the amount by which a laser is cooled, such as may be the case if the laser is cooled by a thermoelectric cooler or some other active cooling system. In other embodiments, the output frequency of a diode laser can be changed through the use of a tuning element either external to the laser chip or integrated as part of the laser chip. Such approaches to tuning a diode laser are known.

In other embodiments, especially where a laser is used as the light source, the resonant frequencies of the microresonator may be tuned instead of, or as well as, tuning the light source. The values of the resonant frequencies of the microresonator are dependent inter alia on the effective refractive index of the microresonator and the physical dimensions of the microresonator: a change in at least one of these factors can result in a change in the resonant frequencies of the microresonator. Accordingly, the microresonator may include a tuning element for tuning its resonant frequencies.

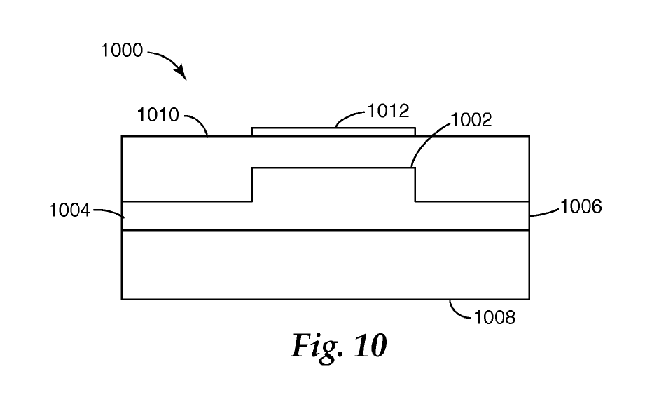

The microresonator tuning element may take any suitable form for altering the resonant frequencies of the microresonator. For example, in the exemplary embodiment schematic illustrated in FIG. 10, a microresonator system 1000 includes a microresonator 1002 and two bus waveguides 1004, 1006 on a substrate 1008. A cladding 1010 overlies the microresonator 1002 and the waveguides 1004, 1006. A tuning element 1012 is positioned proximate the microresonator 1002 for tuning the microresonator frequencies. The tuning element 1012 may take the form of a heating element, such as a resistor, that heats the microresonator 1002. In other embodiments, the tuning element 1012 may be an element that applies pressure to the microresonator 1002, such as a piezoelectric element, or may be an electrode that can be used to apply a voltage across the microresonator, thereby changing the refractive index of the microresonator by changing its carrier density. In other embodiments, the tuning element 1012 may be a cooling element, such as a thermoelectric cooler.

The detector may be any suitable type of detector that can detect the light from the microresonator, and can include a solid state photodetector or a non-solid state photodetector. Some examples of solid state photodetectors include photodiodes, phototransistors, avalanche photodiodes, photoconductors and charge-coupled devices (CCDs). Examples of non-solid state photodetectors include photomultipliers and photon counters. The photodetector may include a single detecting element, or may include an array of detecting elements, for example as in a photodiode array or CCD array. Generally, a photodetector is a device that absorbs a photon and generates an output signal in response to the absorbed photon. In many cases, for example semiconductor-based photodetectors such as photodiodes and phototransistors, the photodetector can detect light over a relatively broad range of wavelengths.

In some embodiments the detector may also include a wavelength selective element, for example a dispersive element or a filtering element, that can be used to provide wavelength selectivity. Examples of such elements include prisms and gratings, multilayer filters, Fabry-Perot filters, fiber gratings, integrated optical gratings, and the like. Typically, dispersive elements, such as prisms or gratings, spatially spread light according to its wavelength. The dispersed light can then be detected using a single photodetector element. The wavelength of light directed to the single photodetector element can be changed, for example by rotating a grating or moving the photodetector element. In such a case, the detected wavelength can be swept over a range of wavelengths. In other embodiments, an array of photodetector elements may be used to detect light at different wavelengths simultaneously. One example of such an arrangement might use a grating as a dispersive element and an array of photodetector elements to detect light over a range of different dispersed wavelengths simultaneously.

Filter elements, such as multilayer filters or Fabry-Perot filters typically permit a narrow band of selected frequencies to be detected at any one time. In some embodiments, such as a tunable Fabry Perot filter, the pass wavelength can be changed. Accordingly, a photodetector, or array of photodetectors, can detect the pass wavelength(s) swept over a range of wavelengths.

A detector is considered to be wavelength selective if it employs a wavelength selective element, irrespective of whether a single photodetector is used to detect the wavelength-selected signal or a photodetector array is used to detect the wavelength-selected signal. A wavelength selective detector may be tunable, i.e. the detector may be able to change the range of wavelengths that are detected at any one time.

Where the light entering the microresonator excited one or more of a first set of resonant microresonator modes, the light scattered by the scattering center excites one or more of a second set of resonant modes that typically propagate within the microresonator in a direction opposite to the propagation direction of the first set of modes. The detector may detect light from one or more modes of the second set of resonant modes. In some embodiments, the detector detects light from at least five modes of the second set of modes and may detect light from at least ten modes of the second set of modes.

The microresonator system may be operated in several different ways, which are associated with different combinations of i) the light source being narrowband or broadband and/or being tunable or fixed wavelength, ii) the microresonator being tunable or not tunable, and iii) the detector being broadband or wavelength selective and/or tunable. For example, a broadband light source may be used to produce the light that is coupled into the microresonator and a broadband detector is used to detect the light received from the microresonator. In such a case, the broadband detector is used to detect light over a substantial fraction, if not all, of the wavelength spectrum emitted by the light source. Such operation may be referred to as wavelength averaging. In such a case the microresonator may be a tunable microresonator or may be untuned.

In another exemplary mode of operation, the microresonator system may incorporate a narrowband light source and a broadband detector. In some embodiments the narrowband light source may be tunable, in which case the light source may be tuned over a wavelength tuning range. In other embodiments the microresonator may be tuned while the wavelength of the narrowband light source is fixed. Some of the light couples into the microresonator when the wavelength produced by the light source corresponds to a resonance of the microresonator, which may lead to a detectable signal. When the light source produces light that is not at a resonance of the microresonator then little or no light is coupled into the microresonator with the result that little or no signal is detected. One method of using such a system is to record the power levels of light received at the detector over a period of time so that the recorded power at each time can be associated with the power at each wavelength of the tunable source or resonant wavelength of the microresonator. A wavelength averaging of the resultant output can be obtained by integrating or summing the recorded power levels during one wavelength scan of the light source or the microresonator. Such wavelength averaging is typically performed digitally, using a computer or microprocessor. The steps of recording the power during wavelength scans and wavelength averaging may be repeated at set scan intervals, for example every few seconds maybe. Changes in the integrated or summed wavelength averaged power over time can indicate the presence of a scattering center. It will be appreciated that in some embodiments both the light source and the microresonator may be tuned.

One approach to operating a system according to one embodiment of the present invention is coupling light from a tunable light source into at least one of a first set of optically guided modes in a microresonator propagating along a first direction within the microresonator; tuning the light from the tunable light source over a first wavelength range; providing a scattering center external to the microresonator; coupling, via interaction with the scattering center, at least some of the light in the at least one of the first set of optically guided modes into at least one of a second set of optically guided modes substantially not excited by the light from the tunable light source; and detecting at least a portion of the light from the at least one of the second set of optically guided modes using a broadband, wavelength averaging photodetector while tuning the light from the tunable light source.

Another approach to operating a system according to an embodiment of the present invention is coupling light from a narrowband light source into at least one of a first set of optically guided modes in a microresonator propagating along a first direction within the microresonator; providing a scattering center external to the microresonator; coupling, via interaction with the scattering center, at least some of the light in the at least one of the first set of optically guided modes into at least one of a second set of optically guided modes substantially not excited by the light from the tunable light source; and detecting at least a portion of the light from the at least one of the second set of optically guided modes using a wavelength-selective detector while tuning the wavelength selective detector.

As used herein, terms such as “vertical”, “horizontal”, “above”, “below”, “left” , “right”, “upper” and “lower”, and other similar terms, refer to relative positions as shown in the figures. In general, a physical embodiment can have a different orientation, and in that case, the terms are intended to refer to relative positions modified to the actual orientation of the device.

While specific examples of the invention are described in detail above to facilitate explanation of various aspects of the invention, it should be understood that the intention is not to limit the invention to the specifics of the examples. Rather, the intention is to cover all modifications, embodiments, and alternatives falling within the spirit and scope of the invention as defined by the appended claims.

1. An optical device comprising:
a light source capable of emitting broadband light;
an optical microresonator supporting at least a first optical guided mode propagating along a first direction and at least a second optical guided mode propagating along a second direction different from the first direction, at least the first optical guided mode being excited by the emitted broadband light without the second optical guided mode being excited by the emitted broadband light; and
a broadband photodetector disposed to receive and wavelength-average light from the at least a second optical guided mode of the optical microresonator.

2. The optical device of claim 1 further comprising:
an input bus waveguide in optical communication with the light source and optically coupled to the optical microresonator; and
an output bus waveguide in optical communication with the broadband photodetector and optically coupled to the optical microresonator.

3. The optical device of claim 1 further comprising a scattering center scattering at least a portion of light in the least first optical guided mode into at the at least a second multiple optical guided mode.

4. The optical device of claim 3, wherein the scattering center comprises a nanoparticle.

5. The optical device of claim 1, wherein the light source comprises a light emitting diode (LED).

6. The optical device of claim 1, wherein the broadband photodetector comprises a semiconductor photodetector.

7. The optical device of claim 2, wherein the optical microresonator, the input bus waveguide and the output bus waveguide are monolithically formed on a substrate.

8. The optical device of claim 1 further comprising:
a bus waveguide coupled to the optical microresonator and coupled to the light source and the broadband photodetector, wherein light from the light source enters the microresonator via the bus waveguide and light from the at least a second optical guided mode of the microresonator reaches the broadband photodetector via the bus waveguide.

9. The optical device of claim 8, wherein the bus waveguide is coupled at a first end to the optical microresonator.

10. The optical device of claim 8, wherein the light source couples light to a second end of the bus waveguide and the broadband photodetector couples light from the second end of the bus waveguide.

11. The optical device of claim 10, further comprising an optical separator element disposed on an optical path from the light source to the second end of the bus waveguide and on an optical path from the second end of the bus waveguide to the broadband photodetector.

12-15. (canceled)

16. A method of operating an optical sensing system comprising:
coupling broadband light from a light source into at least one of a first set of optically guided modes in a microresonator propagating along a first direction within the microresonator;
coupling at least some of the light in the at least one of the first set of optically guided modes into at least one of a second set of optically guided modes propagating along a second direction different from the first direction in the microresonator; and
detecting at least a portion of the light from the at least one of the second set of optically guided modes using a broadband, wavelength averaging photodetector.

17. The method of claim 16, wherein coupling the broadband light from the light source comprises coupling the broadband light to the microresonator via a first bus waveguide.

18. The method of claim 17, wherein detecting the at least a portion of the light comprises coupling light from the microresonator to the photodetector via a second bus waveguide.

19. The method of claim 17, wherein detecting the at least a portion of the light comprises coupling light from the microresonator to the photodetector via the first bus waveguide.

20. The method of claim 16, further comprising introducing a scattering center proximate the microresonator and monitoring a change in detected light resulting from the introducing.

21. The method of claim 20, wherein introducing the scattering center comprises attaching the scattering center to a first molecule that is attracted to a second molecule positioned on a surface of the microresonator.

22. The method of claim 16, further comprising tuning resonant frequencies of the microresonator.

23. An optical device comprising:
a broadband light source capable of emitting broadband light;
an optical microresonator supporting first multiple optical guided modes propagating along a first direction and second multiple optical guided modes propagating along a second direction different from the first direction, the broadband light from the broadband light source exciting at least one of the first multiple optical guided modes without substantially exciting the second multiple optical guided modes; and
a tunable detector disposed to receive light from at least one of the second multiple optical guided modes of the optical microresonator.

24. The optical device of claim 23 further comprising:
an input bus waveguide in optical communication with the tunable light source and optically coupled to the optical microresonator; and
an output bus waveguide in optical communication with the tunable detector and optically coupled to the optical microresonator.

25-80. (canceled)
